(19) United States
(12) Patent Application Publication
(10) Pub. No.: US 2008/0143210 A1
(43) Pub. Date: Jun. 19, 2008

(54) Three-phase motor stator

(76) Inventors: Shyh-Jier Wang, Hukou Township (TW); Li-Te Kuo, Hukou Township (TW); Chau-Shin Jang, Hukou Township (TW); Jen-Chieh Chang, Hukou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/640,877

(22) Filed: Dec. 19, 2006

(51) Int. Cl. H02K 1/12; H02K 1/16

(52) U.S. Cl. 310/216; 310/44; 310/259

(57) ABSTRACT

The present invention provides a three-phase motor stator. The shape of the three-phase motor stator is defined by an optimum pole-tooth ratio for reducing the cogging torque of the motor and increasing the efficiency of the motor. The three-phase motor stator includes at least one plate board. The plate board has a circular hole. A plurality of pole-teeth protrude from the rim of the circular hole and the pole-teeth are symmetric. An opening slot is individually located between two adjacent pole-teeth. The pole-tooth ratio α defined by the tooth angle of a single pole-tooth divided by the pole pitch of two adjacent pole-teeth is between 0.65 and 0.85.

### BACKGROUND OF THE INVENTION

1. Field of the Invention

The present invention relates to a three-phase motor stator. In particular, this invention relates to a three-phase motor stator having an optimum pole-tooth ratio.

2. Description of the Related Art

Increasing the stability and the heat-conducting efficiency of the small-sized fans used in CPUs is the main purpose for fan motor manufacturers. The current fan motor uses a single-phase structure and has a lot of drawbacks. The drawbacks include: (1) a single-phase fan motor must have a hall sensor. Because the hall sensor is sensitive to environmental temperatures, it easily fails in inhospitable environments. The usage life of the hall dominates the usage life of the fan motor. Furthermore, because the hall sensor has to be located under the rotor to sense the magnetic field, it is not easy to make the fan thinner. (2) The single-phase fan motor has larger torque ripple so that that the fan easily vibrates and is noisy. (3) Because the cogging torque for a normal single-phase fan motor has to be far away from the dead point, all fans have to be checked which is time-consuming. (4) Because the single-phase fan motor must have acceptable cogging torque to avoid the dead point, the cogging torque makes the fan vibrate and needs a larger starting voltage. (5) The efficiency of the single-phase motor is lower than that of the multi-phase motor.

The characteristics of the three-phase motor are better than those of the single-phase motor that has been disclosed in a variety of reference books and electrical machinery design handbooks. Three-phase DC brushless senseless motors are commonly applied to office automation machines, including optical drive motors, hard disk motors, and photo-conducting drum motors for laser printers, etc. However, the three-phase motor is still not applied to DC heat-conducting fans.

### SUMMARY OF THE INVENTION

One particular aspect of the present invention is to provide a three-phase motor stator that is installed in a brushless senseless DC heat-conducting fan or a brushless senseless pump motor. The shape of the three-phase motor stator is defined by an optimum pole-tooth ratio. The cogging torque of the motor is lowered and the efficiency of the motor is increased.

The three-phase motor stator includes at least one plate board. The plate board has a circular hole. A plurality of pole-teeth protrude from the rim of the circular hole and the pole-teeth are symmetric. An opening slot is individually located between two adjacent pole-teeth. The pole-tooth ratio α defined by the tooth angle of a single pole-tooth divided by the pole pitch of two adjacent pole-teeth is between 0.65 and 0.85. Furthermore, the diameter of the three-phase motor stator is between 10 mm and 18 mm, and the number of pole-teeth is either 6 or 9.

The shape of the three-phase motor stator of the present invention is defined by the optimum pole-tooth ratio, the optimum diameter range of the stator, and the optimum pole-teeth number. The motor using the optimum three-phase motor stator has lower cogging torque to reduce the vibration and the starting voltage. The hall sensor is not required so the fan can be thinner. The motor using the optimum three-phase motor stator has lower torque ripple so that vibration and noise could be reduced. The three-phase motor does not have a dead point so the fan does not need to be checked, and has higher efficiency.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the three-phase motor stator of the first embodiment of the present invention;

FIG. 2 is a schematic diagram of the three-phase motor stator of the second embodiment of the present invention;

FIG. 3 is a schematic diagram of the three-phase motor stator of the third embodiment of the present invention;

FIG. 4 is a schematic diagram of the three-phase motor stator of the fourth embodiment of the present invention;

FIG. 5 is an exploded perspective view of components of the brushless senseless DC heat-conducting fan;

FIG. 6 is a schematic diagram of the driving circuit for the three-phase fan motor using the present invention;

FIG. 7 is a timing chart of the terminal voltage of the three-phase winding;

FIG. 8 is a schematic diagram of the exciting torque and the cogging torque when the present invention used in a brushless senseless DC heat-conducting fan;

FIG. 9 is a schematic diagram of the current to the rotation speed when the present invention used in a brushless senseless DC heat-conducting fan and a single-phase heat-conducting fan;

FIG. 10 is a schematic diagram of the cogging torque relationship when the present invention used in a brushless senseless DC heat-conducting fan and a single-phase heat-conducting fan; and

FIG. 11 is a schematic diagram of the measured vibrations when the present invention used in a brushless senseless DC heat-conducting fan and a single-phase heat-conducting fan.

### DETAILED DESCRIPTION OF THE PREFERRED EMBODIMENTS

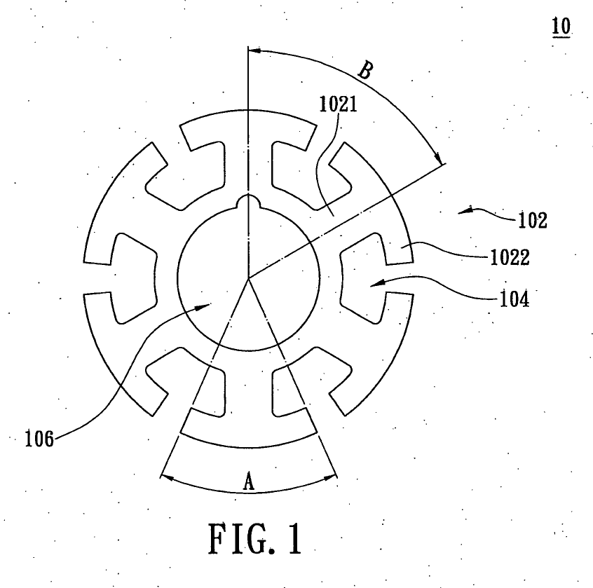

Reference is made to FIG. 1, which shows a schematic diagram of the three-phase motor stator of the first embodiment of the present invention. The motor stator 10 includes at least one plate board (not labeled). The plate board is made of a silicon steel sheet or an iron powder core, and has a circular hole 106. 6 pole-teeth 102 protrude from the rim of the circular hole 106, and the 6 pole-teeth have a symmetric shape. Between the 6 pole-teeth 102, an opening slot 104 is individually located between two adjacent pole-teeth 102. The pole-tooth ratio α defined by the tooth angle A of a single pole-tooth 102 divided by the pole pitch B of two adjacent pole-teeth 102 is between 0.65 and 0.85. The pole-tooth ratio α is defined as a formula (1).

α=A/B (1)

Reference is made to FIG. 1, and formula (1). IF the tooth angle A of the three-phase motor stator 10 is designed to 48 degrees and the pole pitch B is designed to 60 degrees, the pole-tooth ratio α of the three-phase motor stator 10 is 0.8. The pole-tooth ratio α is between 0.65 and 0.85 and meets the conditions defined by this invention.

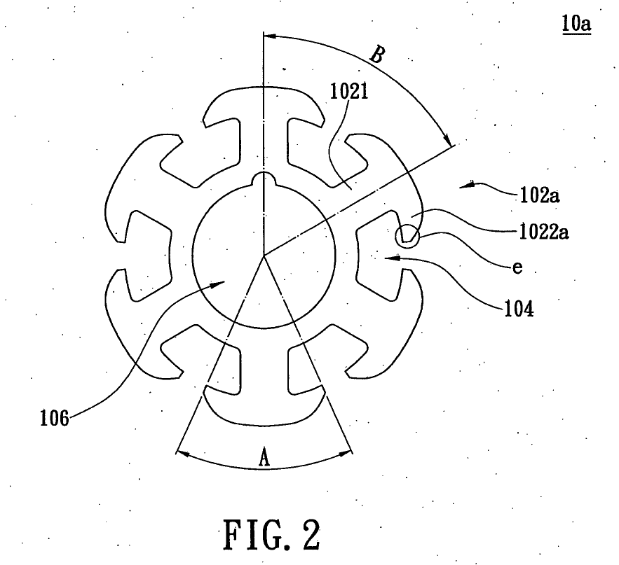

Furthermore, in the first embodiment, the diameter of the three-phase motor stator is designed to between 10 mm and 18 mm. The pole-tooth 102 has a tooth belly 1021 and a tooth edge 1022. The symmetric shape of the pole-tooth is a T-shape, and the tooth edge 1022 has an arc shape. Three-phase windings (not labeled) are wound around 6 tooth bellies 1021. Alternatively, two ends of the tooth edge 1022 extend inwards to form an arc shape and is the second embodiment of the present invention. The three-phase motor stator 10a of the second embodiment includes pole-teeth 102a having arc tooth edges 1022a. Thereby, the cogging torque is reduced. The elements in the second embodiment that are the same as the first embodiment are labeled as the same number, and their functions and operating principles are the same as those of the first embodiment, as shown in FIG. 2.

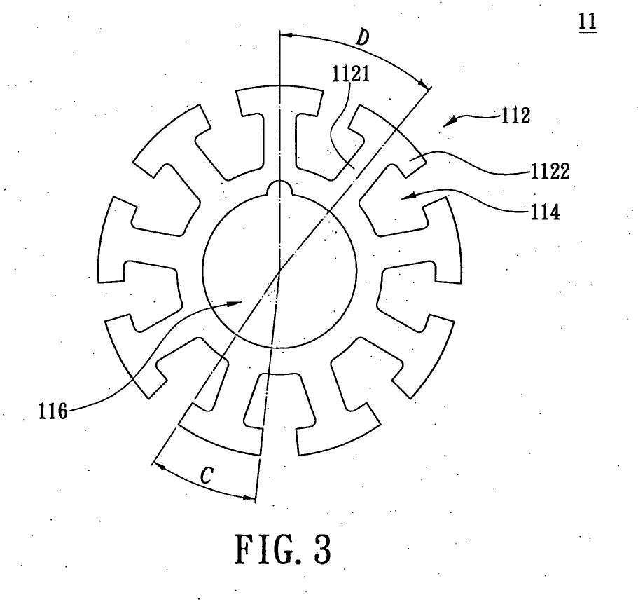

Reference is made to FIGS. 1 and 3. FIG. 3 shows a schematic diagram of the three-phase motor stator of the third embodiment of the present invention. The three-phase motor stator 11 of the third embodiment is almost the same as the three-phase motor stator 10 of the first embodiment, except for the number of pole-tooth 112 being different. In the third embodiment, the motor stator 11 similarly includes at least one plate board (not labeled). The plate board has a circular hole 116. 9 pole-teeth 112 protrude from the rim of the circular hole 116, and the 9 pole-teeth 112 have a symmetric shape. Between the 9 pole-teeth 112, an opening slot 114 is individually located between two adjacent pole-teeth 112. The pole-tooth ratio α defined by the tooth angle C of a single pole-tooth 112 divided by the pole pitch D of two adjacent pole-teeth 112 is between 0.65 and 0.85. The pole-tooth ratio α is defined as the following formula (2):

α=C/D (2)

Reference is made to FIG. 3, and formula (2). If the tooth angle C of the three-phase motor stator 11 is designed to be 28 degrees and the pole pitch D is designed to be 40 degrees, the pole-tooth ratio α of the three-phase motor stator 11 is 0.7. The pole-tooth ratio α is between 0.65 and 0.85 meeting the conditions defined by this invention.

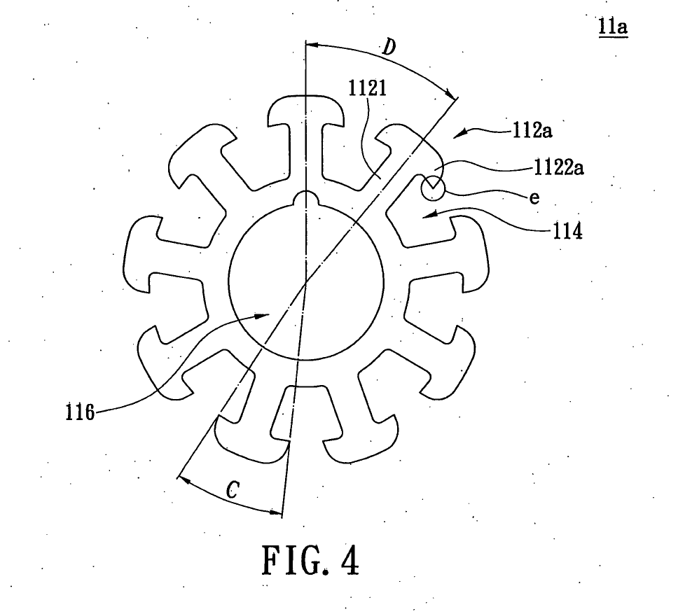

Furthermore, in the third embodiment, the diameter of the three-phase motor stator 11 is designed to be between 10 mm and 18 mm. The pole-tooth 112 has a tooth belly 1121 and a tooth edge 1122. The symmetric shape of the pole-tooth is a T-shape, and the tooth edges 1122 are arc-shaped. Three-phase windings (not labeled) are wound around 9 tooth bellies 1121. Alternatively, two ends of each tooth edge 1122 extend inwards to form an arc shape and the three-phase motor stator 11a of the fourth embodiment of the present invention. The three-phase motor stator 11a of the fourth embodiment includes pole-teeth 112a having arc tooth edges 1122a. Thereby, the cogging torque is reduced. The elements in the fourth embodiment that are the same as the third embodiment are labeled with the same numbers, and their functions and operating principles are the same as those of the third embodiment, as shown in FIG. 4.

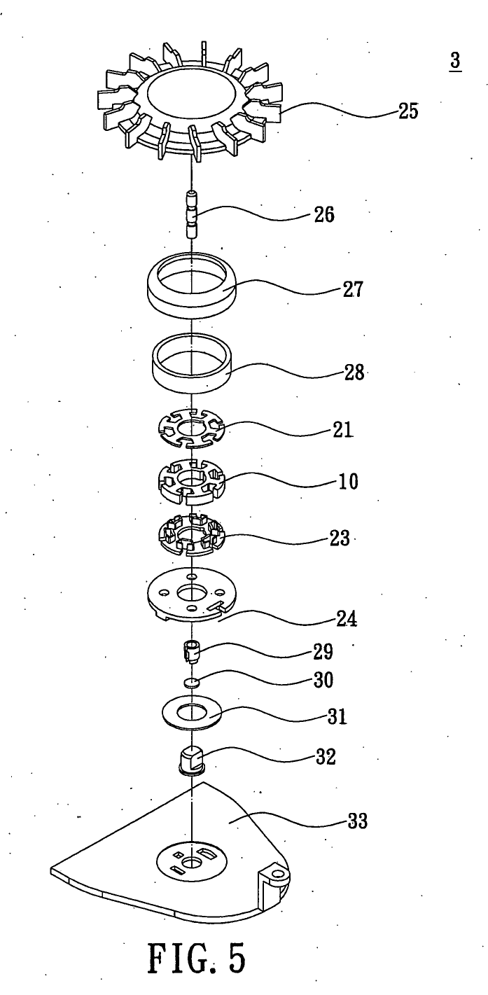

Reference is made to FIG. 5, which shows an exploded perspective view of components of the brushless senseless DC heat-conducting fan. In FIG. 5, the three-phase motor stator 10 of the first embodiment is installed in a brushless senseless DC heat-conducting fan 3. The brushless senseless DC heat-conducting fan 3 includes an upper bobbin 21, a three-phase motor stator 10, a lower bobbin 23, a PCB 24, a fan leaf 25, a shaft 26, a yoke 27, a ring magnet 28, a sleeve 29, a thrust plate 30, an isolation plate 31, a housing 32, and a fan base 33.

Reference is made again to FIG. 5. Coils (not labeled) are wound in the interior of the upper bobbin 21 and the lower bobbin 23 to form a three-phase winding. The upper bobbin 21 and the lower bobbin 23 wound with the three-phase winding covers the three-phase motor stator 10 to form the stator, and the three-phase windings are connected with the PCB 24. The three-phase motor stator 10 covered with the upper bobbin 21 and the lower bobbin 23, the PCB 24, the sleeve 29, the thrust plate 30, the isolation plate 31, the housing 32, and the fan base 33 are assembled in a tight fitness manner.

The ring magnet 28 is formed by staggering a plurality of N poles and S poles of permanent magnets. The yoke 27 covers the outer rim of the ring magnet 28, and is coupled to the shaft 26 to form the rotor. The fan leaf 25, the shaft 26, and the ring magnet 28 are assembled in a tight fitness manner. In the brushless senseless DC heat-conducting fan 3, there is an air-gap of a specified width between the stator and the rotor. Via the stator wound with conducting wires, the stator magnetic field generated by the current flowing through the conducting wire reacts with the ring magnet of the rotor to generate torque. Thereby, the fan leaf rotates.

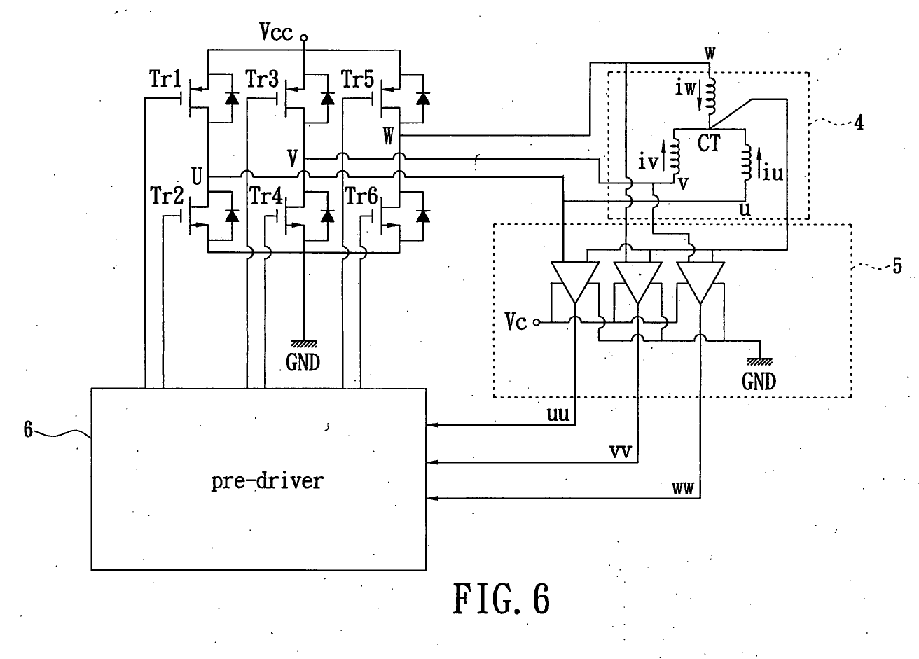

Reference is made to FIG. 6, which shows a schematic diagram of the driving circuit for a three-phase fan motor using the present invention. The three-phase motor 4 having a bipolar driving is used as an example. Therefore, six electronic switches Tr1, Tr2, Tr3, Tr4, Tr5, and Tr6 are required. Many methods are announced to replace the hall sensor, such as sensing the induced electromotive force of the coil, the coil current, or the inductance variation, etc. The winding Y of the three-phase fan motor 4 has u, v, and w phases, and the voltage of the central line (CT) is used as a reference when the motor is driven. The comparator 5 is coupled to the three phases u, v, and w of the three-phase fan motor 4, and compares the voltage of the three phases u, v, and w with the voltage of the CT. Next, the compared result is transmitted to the pre-driver 6. The pre-driver 6 controls the electronic switches Tr1, Tr2, Tr3, Tr4, Tr5, and Tr6 according to the compared result to execute the phase-changing process.

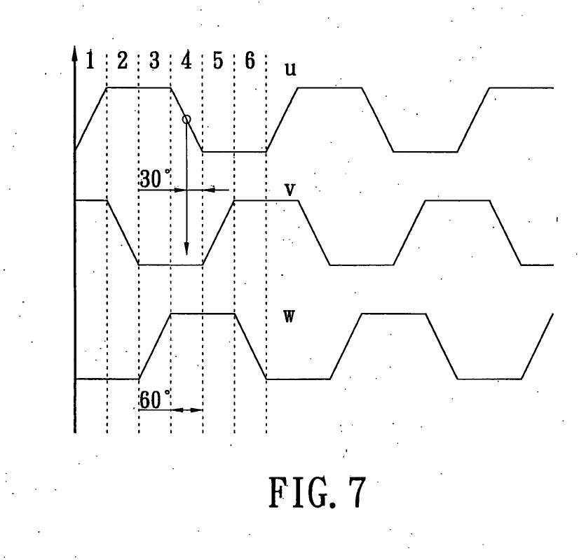

Reference is made to FIGS. 6 and 7. FIG. 7 shows a timing chart of the terminal voltage of the three-phase winding. In the timing chart, the three phases u, v, and w are periodical on six conducting status. Each of conducting status lasts 60 degrees. This phase-changing method is known as a six-step square wave. During the fourth step, phase u is on floating status, and the voltage difference between u and CT is detected to be the induced electromotive force and used for changing a next phase. When the zero-crossing of the voltage difference between u and CT is detected, a delay lasts 30 degrees, then is used as the starting point of the fifth step for changing phase.

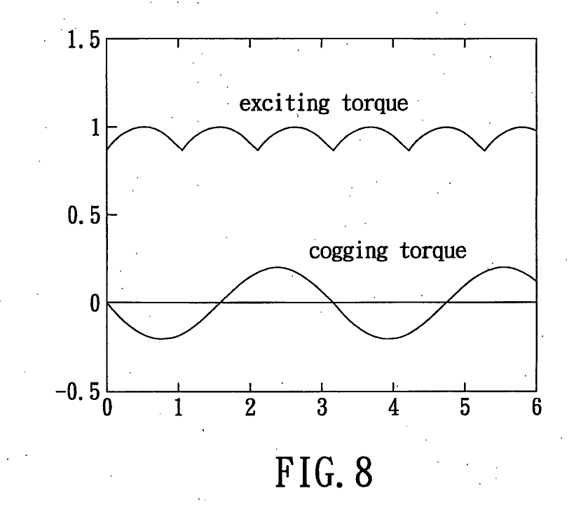

Reference is made to FIG. 8, which shows a schematic diagram of the exciting torque and the cogging torque relationship when the present invention uses a brushless senseless DC heat-conducting fan. After the motor is started and the starting torque is adequate, the exciting torque plus the cogging torque will be larger than zero. In other words, the dead-point does not exist. Unlike the single-phase motor, the checking procedure for the dead-point in the production line is unnecessary. Furthermore, the cogging torque could be decreased to reduce the vibration and noise.

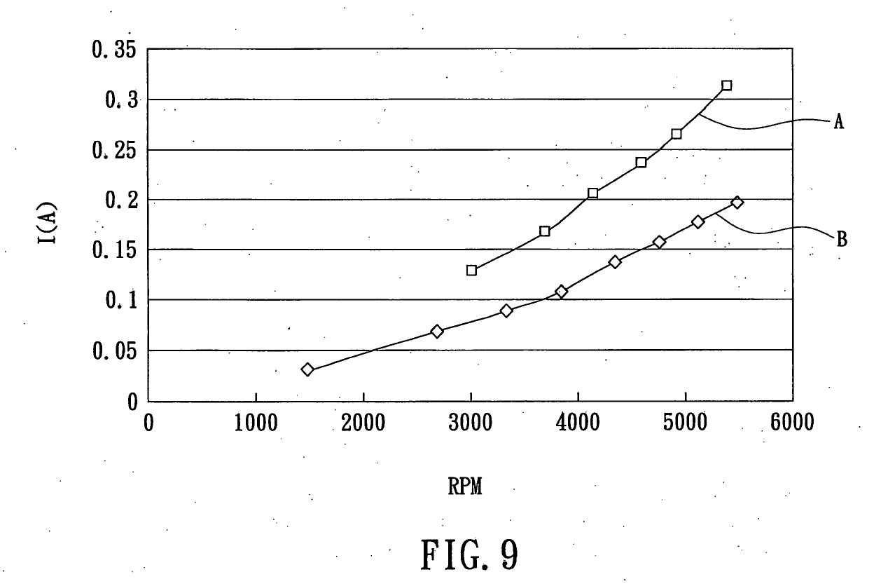

Reference is made to FIG. 9, which shows a schematic diagram of the current to the rotation speed relationship when the present invention uses a brushless senseless DC heat-conducting fan and a single-phase heat-conducting fan. Curve A represents the current to the rotation speed relationship of the single-phase heat-conducting fan. Curve B represents the current to the rotation speed relationship of the present invention using a brushless senseless DC heat-conducting fan. When the loadings are the same each other, the current required for the present invention using a brushless senseless DC heat-conducting fan is lower than that of the single-phase heat-conducting fan by about 25˜30%. Therefore, Due to curves A and B, the operating efficiency of the brushless senseless DC heat-conducting fan is higher than that of the single-phase heat-conducting fan.

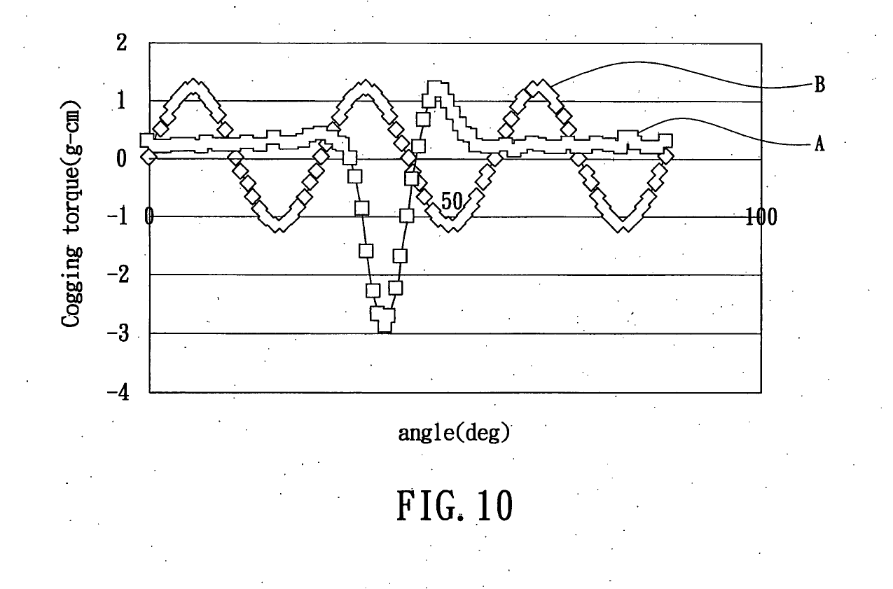

Reference is made to FIG. 10, which shows a schematic diagram of the cogging torque relationship when the present invention uses a brushless senseless DC heat-conducting fan and a single-phase heat-conducting fan. Curve A represents the cogging torque of the single-phase heat-conducting fan. Curve B represents the cogging torque of the present invention using a brushless senseless DC heat-conducting fan. The cogging torque of curve A is larger than the cogging torque of curve B by about 2˜3 times, and the waveform of the cogging torque of curve A is unsymmetrical thereby preventing the dead-point. Thus, it vibrates easily. Due to curves A and B, the cogging torque of the brushless senseless DC heat-conducting fan is lower than that of the single-phase heat-conducting fan.

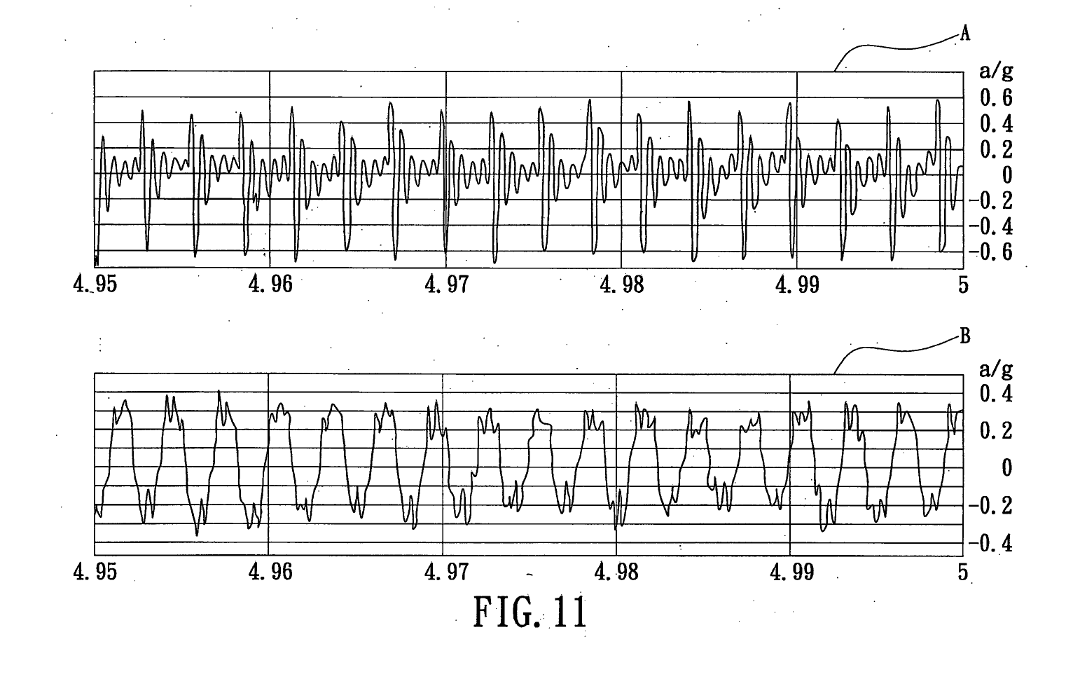

Reference is made to FIG. 11, which shows a schematic diagram of the measured vibration when the present invention uses a brushless senseless DC heat-conducting fan and a single-phase heat-conducting fan. Curve A represents the measured vibration of the single-phase heat-conducting fan. Curve B represents the measured vibration of the present invention using a brushless senseless DC heat-conducting fan. Due to curves A and B, the vibration of the curve A is higher than that of the curve B, and the harmonic vibration of curve A is also higher than that of curve, because the single-phase heat-conducting fan has larger torque ripple and cogging torque.

The shape of the three-phase motor stator of the present invention is defined by the optimum pole-tooth ratio, the optimum diameter range of the stator, and the optimum pole-teeth number. The motor using the optimum three-phase motor stator has lower cogging torque to reduce the motor vibration and the starting voltage. The hall sensor is not required so the fan can be thinner. The motor using the optimum three-phase motor stator has lower torque ripple so vibration and noise is reduced. The three-phase motor does not have a dead point so the fan does not need to be checked, and has a higher efficiency.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A three-phase motor stator, comprising:
at least one plate board, wherein the plate board has a circular hole, a plurality of pole-teeth protrude from the rim of the circular hole and the pole-teeth are symmetric, and an opening slot is individually located between two adjacent pole-teeth;
wherein the pole-tooth ratio defined by the tooth angle of a single pole-tooth divided by the pole pitch of two adjacent pole-teeth is between 0.65 and 0.85.

2. The three-phase motor stator as claimed in claim 1, wherein the diameter of the three-phase motor stator is between 10 mm and 18 mm.

3. The three-phase motor stator as claimed in claim 2, wherein the number of pole-teeth is 6 or 9.

4. The three-phase motor stator as claimed in claim 3, wherein the plate board is made of a silicon steel sheet or an iron powder core.

5. The three-phase motor stator as claimed in claim 3, wherein the symmetric shape of the pole-tooth is a T-shape.

6. The three-phase motor stator as claimed in claim 5, wherein the T-shaped pole-tooth comprises a tooth belly, and a tooth edge.

7. The three-phase motor stator as claimed in claim 6, wherein the tooth edge forms an arc shape.

8. The three-phase motor stator as claimed in claim 6, wherein two ends of the tooth edge individually extend inwards to form an arc.

9. The three-phase motor stator as claimed in claim 6, wherein the tooth bellies of the pole-teeth are wound with three-phase windings.

10. The three-phase motor stator as claimed in claim 1, wherein the three-phase motor stator is installed in a brushless senseless DC heat-conducting fan.

11. The three-phase motor stator as claimed in claim 1, wherein the three-phase motor stator is installed in a pump motor.
